(19) United States
(12) Patent Application Publication
(10) Pub. No.: US 2004/0175684 A1
(43) Pub. Date: Sep. 9, 2004

(54) System and methods for interactive training of procedures

(76) Inventors: Johannes Kaasa, Oslo (NO); Jan Sigurd Rotnes, Oppegard (NO); Vidar Sorhus, Oslo (NO)

Correspondence Address: FINNEGAN, HENDERSON, FARABOW, GARRETT & DUNNER, LLP, 1300 I STREET, NW, WASHINGTON, DC, 20005, US

(21) Appl. No.: 10/483,232

(22) PCT Filed: Jul. 10, 2002
(86) PCT No.: PCT/NO02/00253

(30) Foreign Application Priority Data
Jul. 11, 2001 (NO) 20013450

(51) Int. Cl. G09B 23/28

(52) U.S. Cl. 434/262

(57) ABSTRACT

A computer system for designing and performing interactive training sessions for training persons to perform procedures involving manual dexterity and/or eye-hand coordination, comprising a simulator for performing procedure simulations as well as modules for designing training scenes and procedure descriptions and for, during training, switching between an animation mode based on the procedure descriptions and an interactive mode where a trainee performs the procedures. The designing of training sessions include recording the execution of a procedure performed by an expert and converting this recording to a procedure description containing positional data for instruments as well as additional information including topological stamps indicating the occurrence of topological events in the scene description. During training sessions the system tracks the performance of the trainee relative to the execution represented in the procedure description in order to display guidance information and enable toggling between interactive mode and animation mode.

### BACKGROUND

The present invention relates to computer-aided training of procedures, particularly procedures that depend on a high level of manual dexterity and hand-eye coordination. Examples of such procedures include medical procedures for surgery, such as cardiac surgery, as well as remote control robots that perform critical tasks.

A procedure can be defined as a manipulation sequence necessary for performing a given task. In order for a trainee to acquire the necessary skills enabling him or her to perform the procedure independently, two distinct types of training are necessary. Cognitive training is necessary in order for the trainee to learn the various actions that must be performed and the sequence in which they must be performed, while motoric training is necessary for the trainee to practice the movements that constitute the various actions.

Traditionally, training has been based on performing the actual procedure under the supervision of an expert, or the trainee has been able to practice on animals or human cadavers, physical models, mock-ups or dummies. The last few years computer based interactive training systems that simulate the conditions and the environment encountered during performance of procedures, have been introduced.

One such system is described in WO 98/03954. This system is primarily designed for producing real-time operating conditions for interactive training of persons to perform minimally invasive surgical procedures. This training system includes a housing, within which a surgical implement is inserted and manipulated. A movement guide and sensor assembly within the housing monitors the location of the implement and provides data that is interpolated by a computer processor, which utilizes a database of information representing a patient's internal landscape. U.S. Pat. No. 5,791,907 describes an interactive medical training device which allows a trainee to view a prerecorded video segment illustrating a portion of a surgical procedure. The system requests the trainee to input information relating to the next step in the procedure, such as selection an appropriate medical instrument or selecting a location for operating, before letting the trainee view the next step of the procedure. The system does not include a simulator and does not allow the trainee to attempt to perform the procedure.

Other simulators and training systems are available, but none of these give the trainee the opportunity to watch and learn from a target execution of the procedure he or she is trying to learn, and then try to perform the same procedure using the same simulator system. A target execution in the sense used in this specification refers to an execution of the procedure as it is described in standard text books or as it is performed by an expert in the field, and particularly to an execution performed on a simulation system by an expert and recorded in a way that allows playback of the execution as well as comparison of the target execution with the performance of a trainee.

In particular, none of today's available systems allow the creation of a number of target executions of various procedures in a given environment along with a defined metric for measuring the degree to which the trainee is able to copy the target execution. Finally these systems do not allow for real time switching between an animation mode, where the target execution is played back and viewed by the trainee, and an interactive mode, where the trainee attempts to perform the procedure himself.

### SUMMARY OF THE INVENTION

The present invention facilitates training systems for various procedures that depend on manual dexterity as well as the knowledge of the various actions that must be performed. The invention is based on the concept of combining cognitive and motoric training by enabling two different training modes, a 3-dimensional animation illustrating a target execution of the procedure and an interactive training session where the trainee attempts to perform the procedure using an instrument manipulator device, i.e. some physical interface with the virtual environment of the simulator. It is a further object of the invention to facilitate a way of measuring the quality of the trainee's performance compared to the target execution according to one or more defined metrics. Further, the invention allows for the design of any number of procedures in any given environment, facilitating reuse of designed training scenes. It is also an object of the invention to enable a high degree of interactivity between the two training modes, facilitating a seamless transition between guide animation and trainee execution.

The invention can be described as a system comprising a number of modules that are responsible for the various functions the system performs. These modules will preferably be combinations of hardware and software, but it should be noted that the following description is on a functional level, and that the actual software modules of a system according to the invention may, but do not have to correspond with the modules as they are described here. Instead, the various functions may be distributed between the software (and hardware) modules in ways that differ from the following description.

The core of a system designed according to the present invention is a simulator that at least comprises an input interface for receiving a scene description, an input interface for receiving control signals representing the manipulation of instruments present in the scene description, e.g. as instrument position data, and an output interface for outputting a graphical display of the scene.

In addition to the simulator, such a system further comprises a number of modules that together constitute a designer and trainer. It should be noted that the invention also allows the design of pure training systems that lack the necessary modules for creating scene descriptions and designing procedure descriptions, and also systems that allow for creation of procedure descriptions and training, but lack the necessary modules for creating scene descriptions.

According to a preferred embodiment, a system according to the invention comprises three main designer modules. The first is an object designer, used to design the geometric shape of the objects in the training scene and their physical properties. The second designer module is a scene designer. The scene designer is used to put the objects into correct positions in the training scene and define relations between the various objects, such as dependencies between objects or collision checks in the simulator. The third designer module is the procedure designer. It is used to generate descriptions of target executions of procedures, and to add utility information to these descriptions. This utility information may be related to the execution of the procedure, guidance information, information related to topological or physiological events and how or when they are triggered, etc. The preferred embodiment further includes a training session builder, an animator, an interaction interface, a performance evaluator and a trainer administrator. The builder sets up the training environment by loading a scene description into the simulator and giving the animator and the interaction interface access to a corresponding procedure description. The scene description is a description of the environment, and the procedure description contains a description of the target execution of the procedure. These descriptions have been created using the designer, and it is important that the scene description is the one that was used during creation of the procedure description. The animator is able to run through the procedure description and deliver instrument position data to the simulator, causing the simulator to perform the procedure. In other words, the animation is not merely animated computer graphics. Rather it is an actual simulation with pre-recorded input replacing the input from the instrument interface. The interaction interface receives input from the instruments handled by the trainee, delivers these signals to the simulator, and keeps track of the progress relative to the procedure description in order to display additional information such as guidance information or instructions to the trainee. The performance evaluator compares the execution performed by the trainee to the procedure description and measures the difference according to a defined set of metrics. The trainer administrator manages the other modules of the trainer during a training session.

According to the invention, a system does not necessarily contain all the functionality for both designing training sessions and performing them. The invention therefore also includes a system for designing procedure descriptions for use in a training system. Such a system will comprise the necessary hardware resources for performing computer simulations, along with computer program instructions for sampling input control signals representing manipulation of objects in a training scene while an expert is performing the procedure and storing these samples in an input parameter log, and for creating a procedure description by interpolating positional data from this log in order to create continuous pivotation trajectories supplemented by tables of additional information such as guidance information and information relating to changes in the topology of the scene description.

The invention further includes a system for performing training sessions based on pre-designed geometrical scene descriptions and pre-designed procedure descriptions. Such a system will comprise the necessary hardware resources for performing computer simulations of the relevant procedure, along with computer program instructions for delivering data from the pre-designed procedure description as simulator input in order to perform an animated simulation when the system is in an animation mode and delivering signals from an instrument input device handled by the trainee as simulator input when the system is in an interactive mode, while tracking the progress of the interaction and the animation in order to be able to perform transitions between the two modes.

Such a training system preferably also includes computer program instructions for storing the input from the instrument input device while the system is in interactive mode in order to determine a quality of the trainee's performance by comparing this recording with the procedure description.

The invention also includes methods for creating procedure descriptions for use in training systems and methods for performing training sessions, as well as computer programs for enabling computer systems to perform these methods. A computer program product according to the invention will preferably be stored on some computer readable medium such as a magnetic storage device, an optical or a magneto-optical storage device, a CD-ROM or DVD-ROM, or a storage device on a server in a computer network. The invention also includes such a computer program embedded in a propagated communications signal.

The particular features of the invention are laid out in the independent claims. The dependent claims describe additional features or preferable embodiments.

The invention will now be described in greater detail in the form of examples, and with reference to the enclosed drawings. The examples are illustrative only, and are not intended to limit the scope of the invention as defined by the claims.

While the examples primarily are concerned with medical surgery, the invention is also applicable to the training of procedures in a number of other environments, including, but not limited to, the control of subsurface robots in offshore surveillance and production, remote control of robots handling radioactive material, and remote control of bomb disposal robots.

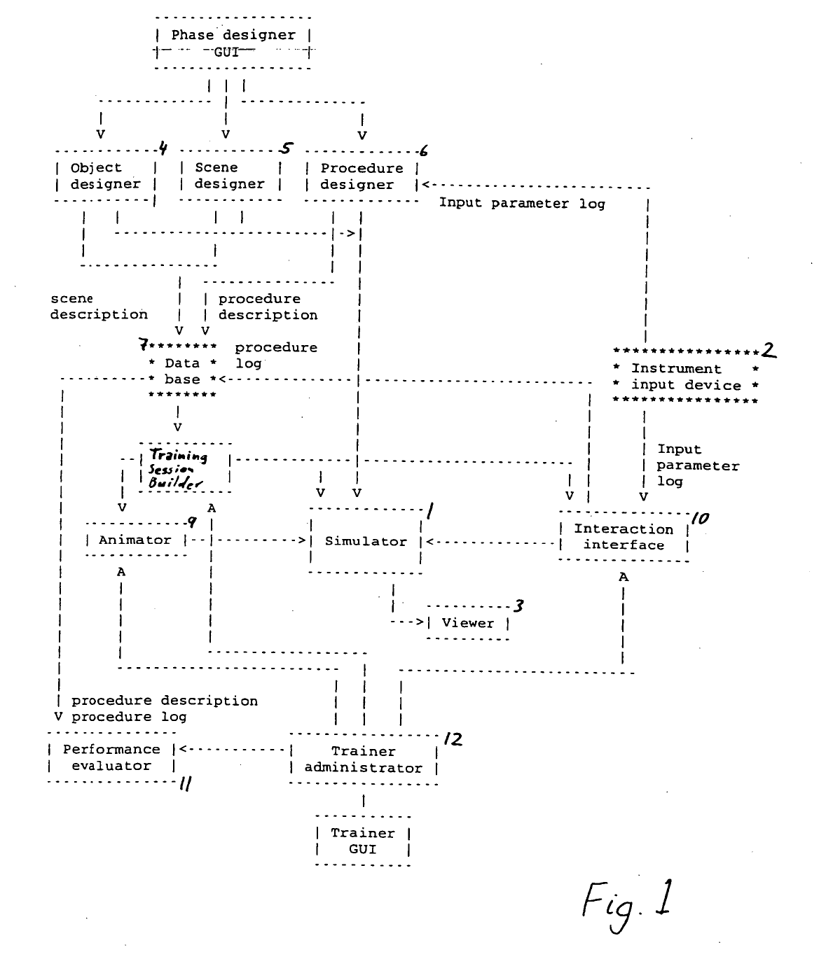

FIG. 1 Shows an overview of the modules of a system according to the invention and illustrates data exchange between them,

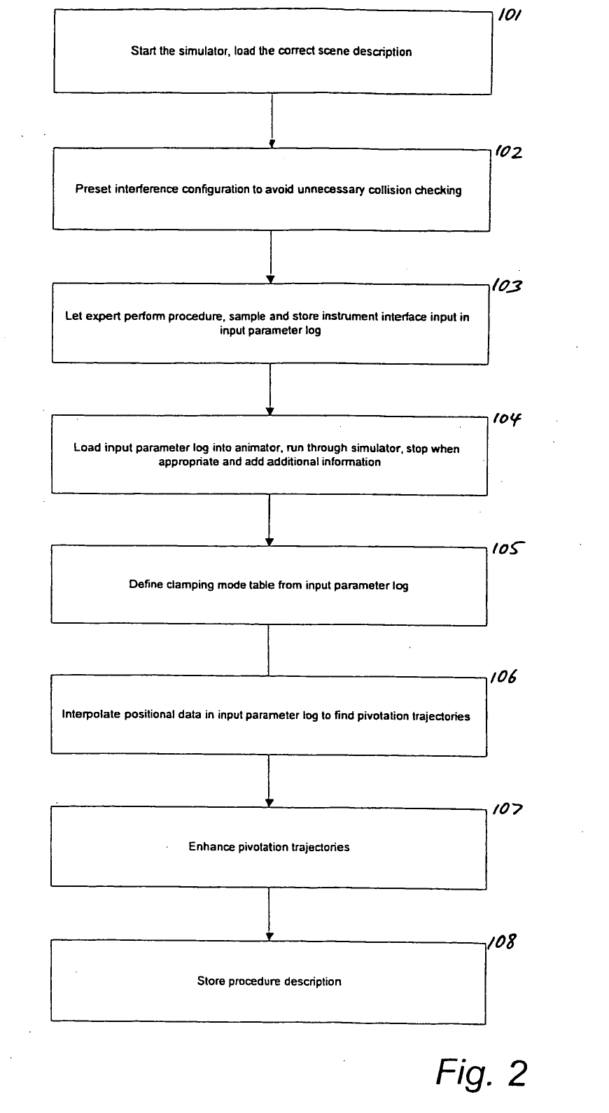

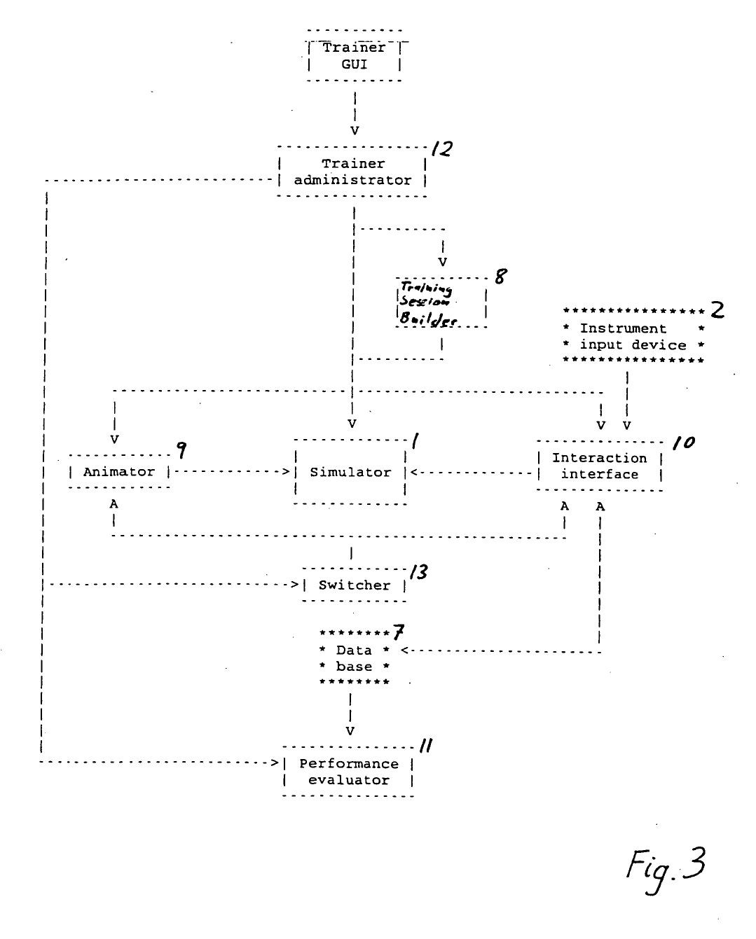

FIG. 2 Illustrates the steps of creating a procedure description,

FIG. 3 Shows an overview of the modules of a system running a training session and illustrates data exchange between them,

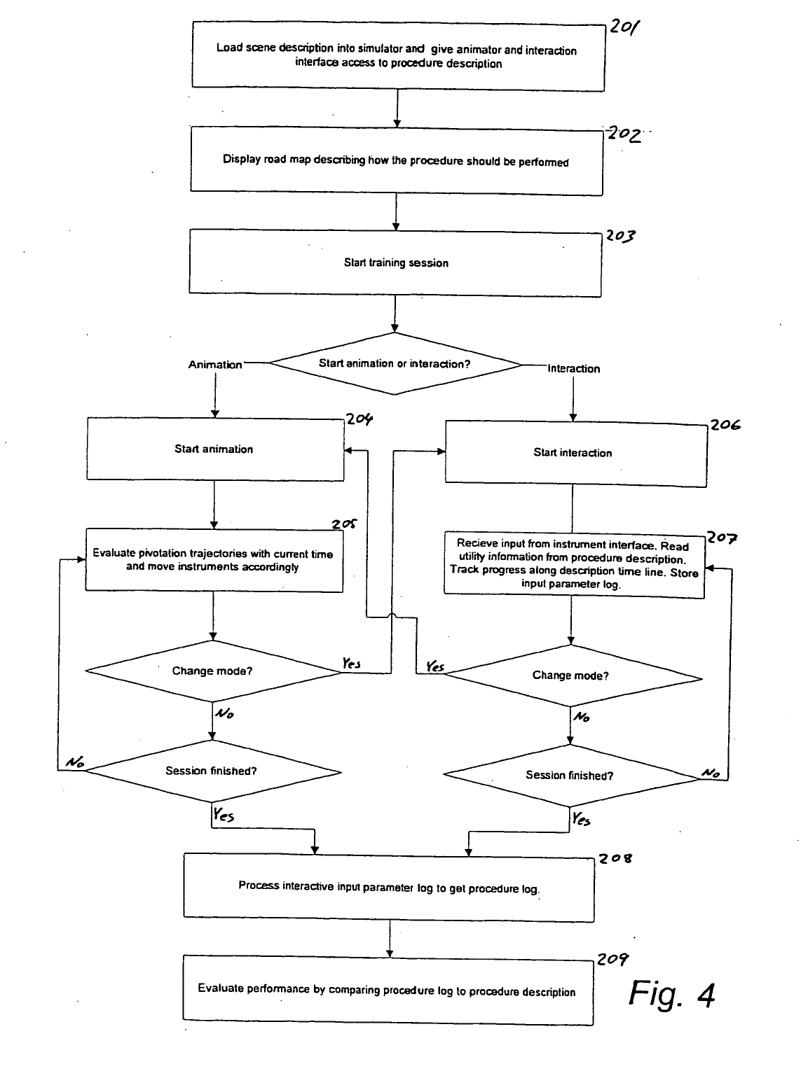

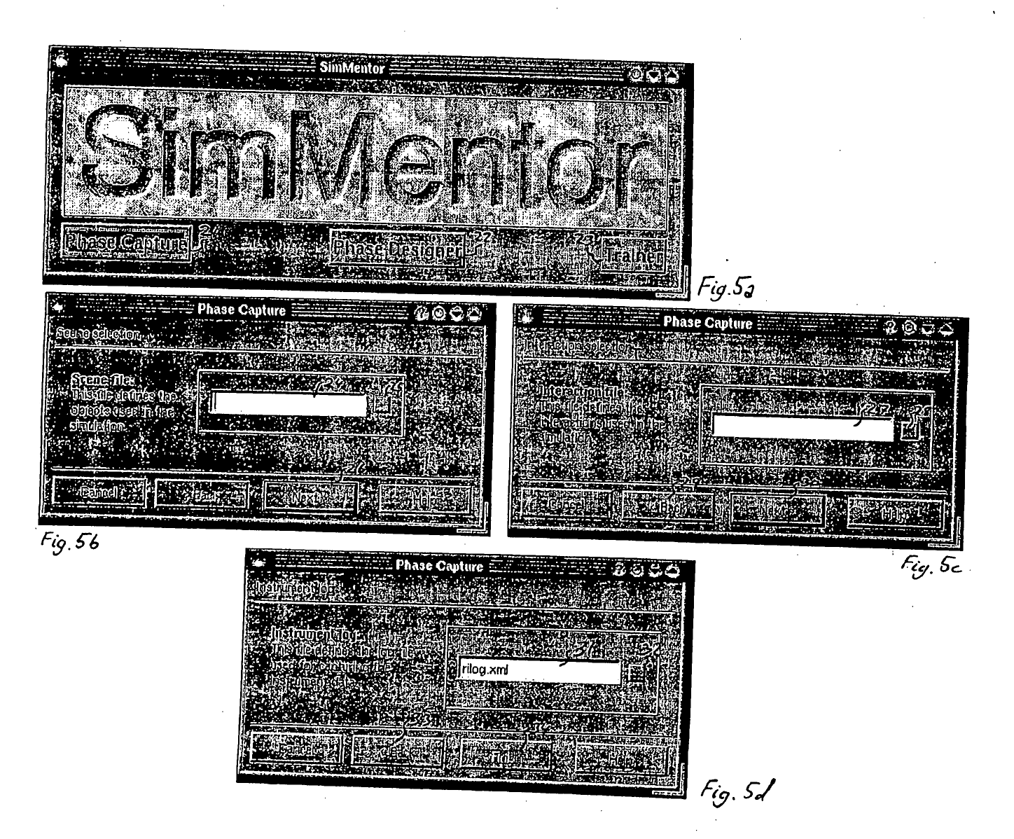

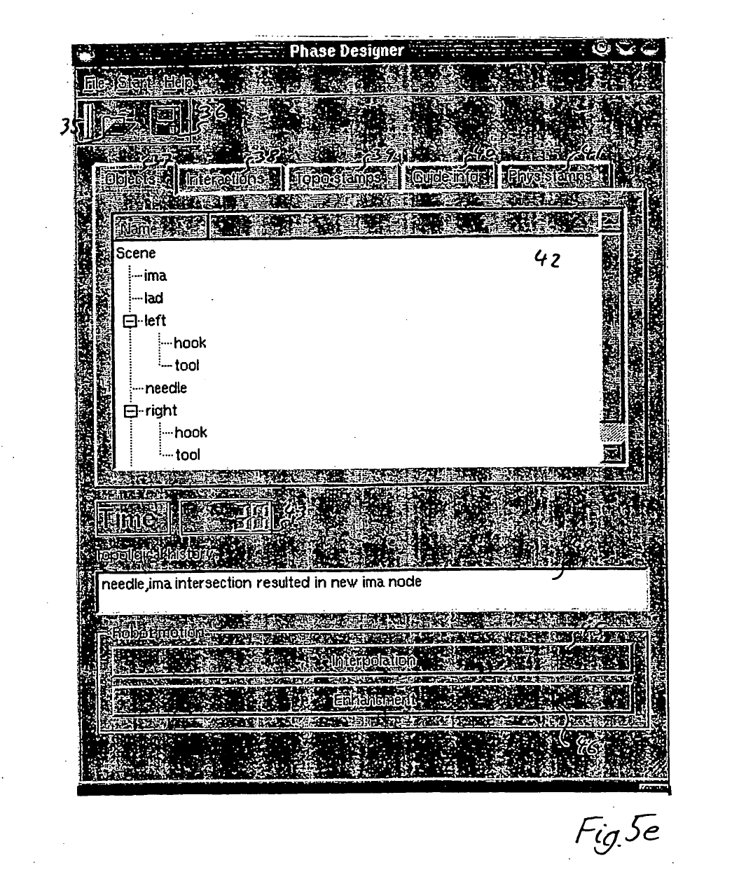

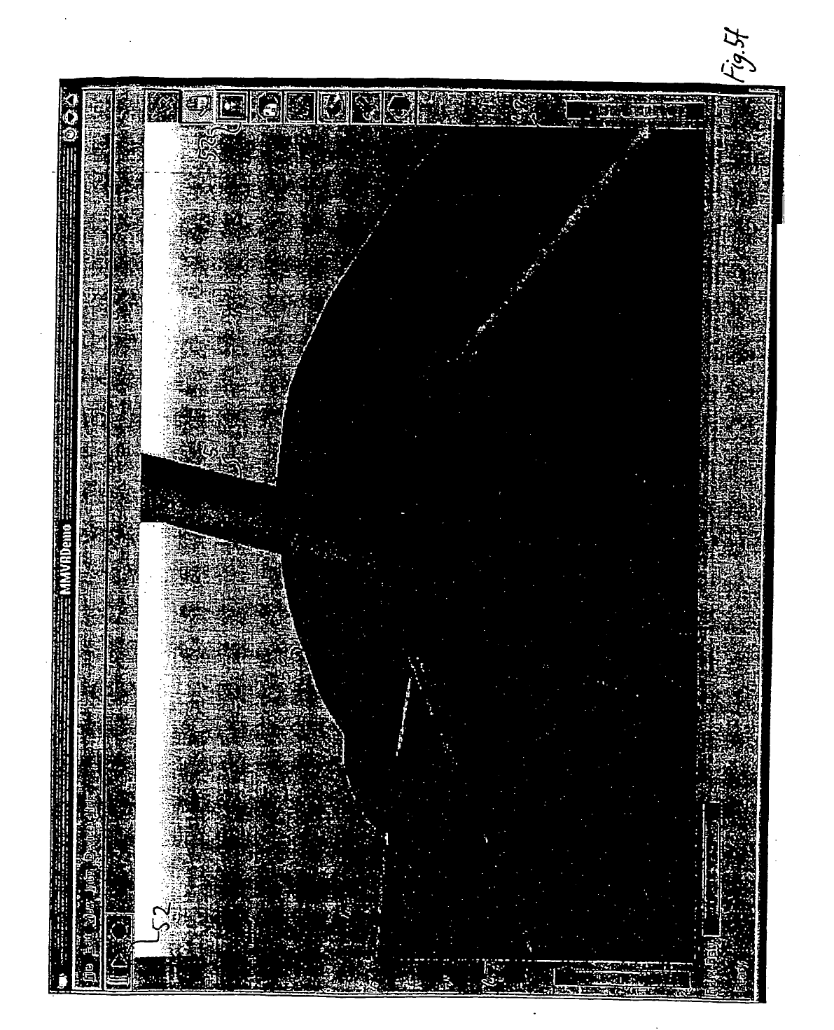

FIG. 4 Is a flow chart illustrating the progress of a training session, and

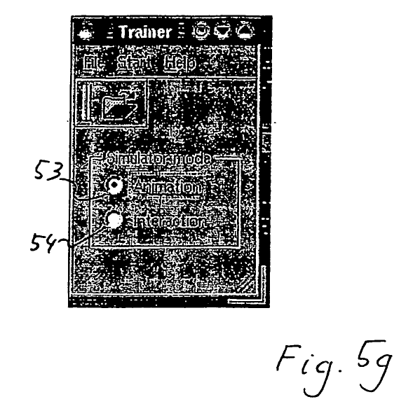

FIG. 5a-g Show possible user interfaces of a system according to the invention.

In FIG. 1, the various modules that make up a preferred embodiment of a training system according to the invention are illustrated. The arrows between modules represent the flow of data between them. According to a preferred embodiment, the modules are software modules running on a computer system with hardware suitable for running the type of simulations to be executed, but it should be noted that some of the functionality of the modules may be replaced by hardware, and also that the actual software modules of a system according to the invention may have some of the functionality moved from one module to another, or modules may be combined or split up into several software modules.

The core of the system is a simulator system comprising at least a simulator 1, an instrument input device or interface 2, and a viewer or graphical interface 3. In addition to this, the system comprises a number of modules for designing a training environment and for performing training sessions. Some of the modules described below are used in order to create the environment for training and a target execution of the procedure the trainee is supposed to learn, while other modules are used when performing a training session.

The first of these modules is an object designer 4. The object designer 4 is used to design the geometric shape and physical properties of the objects that make up the training environment. The next module is a scene designer 5, which is used to place the objects in their correct positions in the training environment and define the relationships between them. The object designer 4 and the scene designer 5 may in principle be any suitable object oriented tools for construction of graphical models of an environment. Preferably, however, the objects are constructed as geometric shapes defined using splines, and the scene is constructed as a scene graph, as is well known in the art. The resulting environment is stored in a database 7 as a scene description.

Suitable well known application programming interfaces (API), libraries, and tools that may be included in the object designer 4 and the scene designer 5 include OpenGL®, Open Inventor and Coin. OpenGL is an API that was originally developed by Silicon Graphics, Inc. and that is maintained as an industry standard by the OpenGL Architecture Review Board. Open Inventor is an object-oriented toolkit for developing interactive 3D graphics applications. Open Inventor is available from Silicon Graphics, Inc. Coin is a software library for developers of 3D graphics applications. It is an implementation of the Open Inventor API, and is available from Systems In Motion AS. The next module is a procedure designer 6. This module is used to generate the target execution of the instruments during the procedure. The target execution is the sequence of actions and movements the trainee is trying to copy when performing the procedure. The target execution is created by loading the scene description into the simulator 1 and letting an expert perform the procedure. The input parameters from the instrument input device 2 are sampled with a suitable sampling frequency and stored in the database 7 as an input parameter log. These sampled data will normally consist of instrument positional data and clamping mode information for the instruments.

The input parameter log is subsequently used by the procedure designer 6 in order to create a procedure description. This process is described in further detail below, with reference to FIG. 2. The procedure description is associated with the scene description used when it was created, and stored in the database 7.

In order to perform a training session, the relevant scene description and procedure description must be loaded. This is performed by a training session builder 8. The training session builder 8 reads the scene description and the procedure description from the database 7 and loads the scene description into the simulator 1, while the procedure description is made available to an animator 9 and an interaction interface 10. The animator 9 is able to run through the procedure description and deliver instrument positions to the simulator together with any interference information and utility information included in the procedure description. Interference information and utility information will be described below. According to a preferred embodiment it will also be possible to load an input parameter log into the animator. The animator will then deliver the raw input data to the simulator at the recorded sampling rate. No interference or utility information will be available from the input parameter log. Also, the input parameter log is not convenient for determining the quality of the performance of a trainee, as described below. The animator is primarily used to demonstrate an execution of the procedure that is considered to be correct, but it is also used during procedure design in order to navigate through a recorded procedure execution and edit the procedure description. Alternatively a separate module for feeding the input parameter log data to the simulator could be used during the procedure design.

The interaction interface 10 receives the input information from the instrument input device or interface 2 and delivers these to the simulator when the system is in interactive mode, which means that the trainee is in control of the simulator. The interaction interface 10 also tracks the execution of the procedure by the trainee relative to the time line and/or progress of the procedure description and delivers utility information to the simulator at defined moments or in defined situations for this information to be displayed. Examples of this could be a visual marker indicating where to insert a surgical needle, highlighting an area where an instrument or other tool is supposed to be applied, an arrow or a line indicating a direction of motion, written instructions and so on.

In the same way as during the procedure design, an input parameter log is created while the trainee controls the simulation. This log is the basis for the evaluation of the trainee's execution of the procedure. The input parameter log is converted to a procedure log and stored in the database 7 much in the same way as the input parameter log of the target execution is converted to a procedure description. This can be performed by the procedure designer 6, or by a separate module. It would also be possible to include this functionality in the procedure evaluator 11 or the interaction interface 10. The creation of the procedure log is described in further detail below.

The performance evaluator 11 is a module that reads the procedure description and the procedure log from the database 7 and determines the quality of the trainee's execution of the procedure based on defined criteria. What these criteria will be depends on what kind of procedure the trainee is trying to perform and which criteria are considered crucial in order to measure success. The criteria could include time to complete the procedure, a measurement of effectiveness of motions (distance instruments have been moved, deviation from an optimal path etc.), sequence of distinct actions, accuracy of various positionings and so on. According to a preferred embodiment the trainee will be able to turn off some or all of these criteria. This can be convenient for example for a trainee with little or no skill, where it is only of interest to measure the quality of the results of the procedure, not the time it takes the trainee to complete it.

Finally the trainer administrator 12 is a module that manages the other modules that are used during training. The trainer administrator 12 controls the start of a training session with loading of the necessary descriptions through the training session builder 8, it can toggle the system between demonstration mode (animation) and interactive mode, and it starts the performance evaluator 11. In order to successfully switch between demonstration mode and interactive mode, the trainer administrator 12 matches the progress of the animator 9 and the interaction interface 10. This module also sets up the right visualization mode according either to information in the procedure description or based on selections made by the trainee. The visualization modes can include a global viewpoint, viewpoint connected to an instrument, surface visualization, volume visualization, 2D or 3D (stereo vision), a hybrid of animated computer graphics and pictures/video, and a selection of transparent or opaque.

Reference is now made to FIG. 2, which illustrates the steps of a preferred way of creating the procedure description. In the following, it is assumed that the scene description has already been created, preferably using tools that are well known in the art. The procedure description is a file containing a description of the target execution of the procedure. It is used by the animator for running an animation of the target execution, and it is also used during evaluation of the trainee's performance, as described in further detail below. The file may contain additional information, such as guidance information presented to the trainee whether the simulator is running an animation or in interactive mode, as well as other utility information describing particular conditions or events.

In order to create a procedure description, the correct scene description is loaded into the simulator (step 101). Following this, an interference configuration is preset in the simulator (step 102). This includes context dependent information that is used to avoid unnecessary collision checking.

The procedure is then performed by a person considered to be an expert in the relevant field (step 103). During this execution of the procedure, the input parameters from the instrument input device are sampled at a suitable sampling rate, and the resulting samples are stored in an input parameter log with the following file format:

<time> instrument1 <parameter value 1> <parameter value 2> ...
instrument 2 <parameter value 1> ...

A preferred sampling rate is once per picture frame in an animated presentation of the simulation, typically 25-30 samples per second.

As an alternative to starting the recording of the simulation immediately following the loading of the scene description into the simulator, the recording can be started during an ongoing simulation. In this case, the simulation must be halted and the current scene description must be saved, together with the velocity values in the interrupted situation, in order to restart the simulation with the same conditions as at the interruption.

After the simulation of the procedure has been completed and the input parameter log has been created, the input parameter log is loaded into the animator 9. The recording is run through and stopped at appropriate places where additional information is added (step 104).

The criteria for stopping the animation in order to add information can be based on automatic detection of certain predefined conditions such as particular topological events (objects are brought into contact with each other or the topological make-up of the scene is changed for example as the result of some object being cut or disconnected), or the animation can be stopped manually by an operator. When the animation stops or is stopped in this manner, information can be added by the operator. Examples of information that can be added include topological stamps (markers that define or describe topological events), guidance information (information to be displayed during the training to help the trainee understand or perform the procedure), interference information and physiological stamps (or environmental stamps).

Interference information is information that indicates when and between which objects the simulator is to perform collision checks. These checks are very demanding, and the simulator operates faster if these checks can be limited.

Physiological (or environmental) stamps are similar to topological stamps except they define or describe physiological events or environmental events, not topological events. Examples of a physiological event could be that a patient starts bleeding, that radiation levels or temperature increases etc. Topological and physiological stamps and guidance information are examples of utility information.

For most procedures the trainee will have to use various instruments to grab and manipulate other instruments or objects. In a number of cases it will be important whether an instrument has a firm grip on an object or whether the object is allowed to shift, turn, pivot or in other ways shift position if it is brought into contact with another object. Whether the instrument holds the object in a firm grip or not can usually not be determined simply by whether the instrument is open or closed, since all positional data for the instrument will be the same whether the grip is firm or loose. Accordingly, a clamping mode table is generated from the input parameter log (step 105).

The positional data of the instruments in the input parameter log are then interpolated in order to find pivotation trajectories (step 106). According to a preferred embodiment, the position of an instrument is given as four values, 3 angles representing its orientation, and an in/out translation value representing how far into the scene the instrument is located. Preferably, the angles are transformed to quaternions and interpolated in a quaternion space. The translation is interpolated as a 1-dimentional spline curve. This gives the embodiment a continuous representation of the movements of the instruments, which makes enhancements possible. It also facilitates evaluation of the position of the instruments outside the sampling points. Different training scenes and procedures may call for different sets of parameters and other representations of them. These will all be within the scope of the invention.

Quaternions is preferred when the orientation of the instruments is described, since this is a preferred representation in the animation society. Each change of orientation from an initial setup is described by 4 numbers: 3 numbers indicate a rotation axis and 1 number indicates the rotational angle around this axis. This 4-tupple is normalized and placed on a unit-sphere in the 4-dimentional space. We then utilize special interpolation methods to generate interpolation curves that lies on the sphere. A reference to such a method is: “Animating Rotation with

Quaternion Curves”, Ken Shoemaker, Computer Graphics, Vol. 19, No. 3, pp. 245-254.

Finally the pivotation trajectories are enhanced (step 107). This can be done automatically, for instance by minimizing arc length or curvature of the trajectories, or manually, as manipulation of the interpolated curves, by interactively moving points connected to them. The purpose of this step is to remove unnecessary or erroneous movements performed by the expert during recording of the target execution, or in other ways improve the target execution.

A preferred file format for the procedure description will contain pivotation trajectory for each instrument as a data reduced and faired interpolation of the positional data in the input parameter log, and event descriptions stored in the following tables:

Topological stamps:
<time><event type>
Clamping mode:
<start time><end time><instrument><clamping mode>
Guidance information:
<start time><end time><position><guidance type>
Interference:
<object 1><object 2><interference type><start><end><start><end>
Physiological stamps:
<start time><end time><position><physiological event>

It should be noted that the number and precise nature of these tables depend on the procedure and the simulation environment. Some tables will always be present, while some may be omitted or are more relevant in some applications than in others. Physiological stamps are particularly relevant in surgical applications, but information related to other environmental conditions could be tabulated in a similar manner. Both the pivotation trajectories and the tables are time dependent and are defined with regard to the same time scale. This makes it straightforward to match the progress of the instrument movements with the events described in the tables. The time scale may be associated with a progress scale defined by the sequence of topological stamps or some other division of the procedure description into phases or other subintervals, in order to simplify the bookkeeping of progress while a trainee performs the procedure in interactive mode.

The procedure description may also contain criteria that when fulfilled will stop the training session. This may e.g. include topological events that are not allowed to occur or topological events that are not allowed to occur in an order other than that defined by the sequence of the topological stamps in the procedure description. This is because a trainee may make irreparable mistakes, such as performing actions that make it impossible to complete the procedure in a meaningful way.

The finished procedure description is stored in the systems database (step 108).

It should be noted that it would be possible to omit one or more of the steps described above, and to a certain degree the sequence may be altered or some steps may be repeated. E.g. it would be possible to add some additional information to the procedure description (step 104) after the pivotation trajectories have been generated (step 106).

Reference is now made to FIG. 3, which illustrates the modules of a system running a training session. This can be an all purpose system as illustrated in FIG. 1, or a training station which lacks the capabilities necessary for constructing scene descriptions and procedure descriptions. The data flow between the modules is also illustrated. Modules in FIG. 3 corresponding to modules illustrated in FIG. 1 are given the same reference numerals. The only module that is not present in FIG. 1 is the switcher 13 which should be interpreted as a sub-module of the trainer administrator 12. The dataflow illustrated results from the steps performed during a training session, as illustrated in FIG. 4.

FIG. 4 illustrates the general steps performed during a training session. In a first step (step 201) the simulator 1 is started and the relevant scene description is loaded. In addition the procedure description is loaded in order to make it available to the animator 9 and the interaction interface 10. Care is taken to ensure that the scene description is the one that was used during the creation of the procedure description, as described with reference to FIG. 2. This can be done in a number of ways. It would be possible to bundle the scene description and the procedure description, but for many purposes it will be desirable to enable the loading of one of a number of different procedure descriptions using the same scene description. According to a preferred embodiment, the procedure description therefore includes a reference that identifies the scene description on which it was created, and a check is preformed to ensure that the procedure and the scene correspond before the procedure description can be loaded or started. The training session builder 8 performs these tasks.

Preferably the trainee is presented with a road map prior to the start of the actual simulation (step 202). This road map can consist of text and/or snap shots from the target execution (the execution of the procedure description), but other ways of presenting guidance information are possible, such as diagrams, actual maps (if the procedure involves navigating in an environment such as a mine or a nuclear power plant), audio presentations etc. The road map information will preferably be included in the procedure description and the administration of this presentation can be handled by the training session builder 8 and/or the trainer administrator 12.

After the road map has been presented, the actual training session is started (step 203). According to the invention, two modes are available, an animation mode and an interactive mode. The session may start in either mode, and at any time during the session, the system can toggle between these modes. How the actual toggle between modes is performed is described in further detail below.

If the animation is started (step 204), the pivotation trajectories in the procedure description are evaluated in order to derive input parameters to the simulator in a timely manner (step 205). It should be noted that since these trajectories are stored as continuous interpolations, the progress of the animation is independent of the sampling rate used during the recording of the target execution of the procedure. The simulator moves the instruments in accordance with the input parameters delivered from the animator 9. The tables included in the procedure description, such as clamping mode and interaction, are checked and the simulation is performed based on this. This animation will continue until either the mode is switched to interaction or until the end of the procedure is reached.

Whenever the interactive mode is started (step 206), whether as the beginning of the simulation or as a result of toggling from the animation mode, the simulator starts receiving input from the instrument input interface (step 207). In addition, utility information is read from the procedure description by the interaction interface 10. This includes topological stamps, guidance information and physiological stamps. The topological stamps are, among other things, used in order to locate the progress of the trainee on the time scale/progress scale of the procedure description. This is necessary in order for the interaction interface 10 to handle display of guidance information and act correctly on physiological stamps, and also in order to perform a transition from interactive mode to animation mode, as described below. The interaction interface also samples and stores input parameters in an input parameter log in the same way as during construction of the procedure description.

Unless the mode is switched to animation, the trainee will continue to control the simulator until the procedure has been successfully completed (as determined by the interaction interface 10 based on topological stamps and possibly other criteria such as time out or the occurrence of certain events).

When the session is finished, the input parameter log is processed much in the same way as during the creation of the procedure description (step 208). In a system that includes the capability to create procedure descriptions (as described above), the procedure log will preferably be created in the procedure designer 6. In a system that lacks this capability and is only designed for performing training sessions, the necessary functionality for creating a procedure log based on the input parameter log can be included in the interaction interface 10 or the performance evaluator 11, or in a separate module that includes a subset of the functionality of the procedure designer 6. The procedure log will include pivotation trajectories generated in the same manner as described above for the procedure description, except that they will be based directly on the input parameter log without any enhancement. In addition the procedure log will include topological stamps that correspond with the topological stamps in the procedure description, and a clamping mode table. The rest of the tables included in the procedure description are omitted from the procedure log, but the procedure log preferably includes two additional tables. The first additional table contains start time and end time of each interactive interval of the training session. The second additional table is a table of <<other events>>. This table indicates the occurrence of pre defined events that influence the quality of the trainee's performance, and may include unintentional collisions between instruments and objects, and critical errors like piercing the opposite wall of a vessel wall being sutured, or not setting a stitch through all the layers of a tissue wall.

When the procedure log has been created, it is compared with the procedure description in order to determine a measurement of the quality of the procedure log according to given criteria (step 209). These criteria depend on the type of procedure the trainee is trying to learn to perform, and may include the distance instruments have been moved, deviation from an optimal path, the sequence of distinct actions, time to complete the procedure etc. This can be done by comparing the pivotation trajectories, the topological stamps, the clamping mode tables and time stamps of the procedure description and the procedure log respectively.

According to a preferred embodiment, the performance evaluator will read the procedure description and the procedure log from the database 7 and do a comparison based on three criteria. These are the efficiency of the instrument or instrument movements, the sequence of topological events and the occurrence of other events as described above. The efficiency of the instrument movements is measured by comparing each instrument trajectory in the procedure log with the corresponding trajectory segment in the procedure description and evaluating them with regard to speed, arc length and smoothness.

The transition from animation mode to interactive mode can be implemented relatively straightforward. It is simply a matter of starting the interaction with the instruments in the positions they have been placed as a result of the animation and with the simulated model as it was at the interruption, so that objects other than the instruments controlled by the trainee continue to behave as they did. In this way it is for example possible to ensure that there is no discontinuity in the beating of a heart or other movement of objects in the scene.

Transition from interactive mode to animation mode is more demanding, since the system must go from a basically random state to a predetermined state. This means that two problems must be solved.

The first problem is to determine from where on the time line of the animation (the target execution of the procedure described in the procedure log) the animation should be resumed. In other words the situation at the termination of the interaction phase must be mapped onto the time line of the procedure description. In most cases it will be possible to determine which topological stamps the interaction has gone through and thereby locate the situation inside a topological subinterval of the time line. However, it is more difficult to determine an exact point on the time line within this subinterval. Since the trainee's movements of the instruments will not correspond exactly with the movements described in the procedure description, there is no point in time within this subinterval that, strictly speaking, is correct. Rather, the problem is to find a point in time that, in some sense, is most convenient. This must be based on ad hoc rules, for instance trajectory distances. In other words, that point in time along the time line of the procedure description is found at which the instruments are in positions that are closest to the positions of the instruments at the end of the interactive phase.

Following the time matching, a trajectory matching must be performed. The invention includes four alternative ways of performing this. An appropriate method must be selected based on the advantages and disadvantages of each compared with the system designer's needs and available resources in the given circumstances.

The first alternative is simply to restart the procedure. This is easy to implement, but not very satisfying for the trainee. The second alternative is to restart the animation from a topological stamp, preferably the closest previous topological stamp. It is relatively simple to find the latest stamp before the interruption of the interaction and start the animation from there. To speed up this process all the animation data can be stored at each topological stamp, i.e. not only the trajectories, but also the position and speed of each node included in the geometric modeling of objects other than the instruments. An even more sophisticated alternative is to restart the animation from a matching point on the time line, preferably the point in time found during the time matching described above. This is rather more challenging, since only the trajectories at this point will be stored in the procedure description, not the complete animation. The most sophisticated alternative is to find a trajectory interpolation from the present position of the instruments at the time of interruption and onto the predefined trajectories stored in the procedure description and let the instruments move from the present position until they catch up with the procedure description. This will often be possible, but it is difficult to make sure that collisions will not occur because of objects that are between the present position of the instruments and the position where the instruments catch up with the stored trajectories, such as an instrument passing through tissue.

According to a preferred embodiment, the procedure in the procedure description is divided into a number of phases. In this case a training session may consist of one or more phases, and a trainee may choose to start a training session from the beginning of any phase. Each phase is subdivided into the intervals between topological stamps. Everything described above with relation to a procedure description will be true also for individual phases or sequences of phases. Actually, the case where the procedure is not divided into phases may be considered as the special case with only one phase. It must therefore be understood that unless context dictates otherwise, the terms procedure and phase are interchangeable in this specification; i.e. what holds true for one also holds true for the other.

Reference is now made to FIGS. 5a-i, which illustrate possible user interfaces of a system according to the invention.

FIG. 5a shows a possible initial window or dialog box of a system according to the invention. The window gives the user three choices of invoking various modules of the system. The embodiment illustrated does not include modules for designing the scene (object designer 4 and scene designer 5). The illustrated choices include phase capture 21, phase designer 22 and trainer 23. <<Phase Capture>> 21 starts the procedure designer 6 in recording mode in order for an expert to perform the target procedure on the simulator 1. <<Phase Designer>> 22 starts the procedure designer 6 in editing mode for creation of a procedure description based on the input parameter log created during the experts execution of the procedure. <<Trainer>> 23 starts the trainer administrator 12 and allows a trainee to start a training session.

It should be noted that the particular embodiment illustrated allows for the design of procedures consisting of several phases that may be designed and performed individually or sequentially. Because of this, the word <<phase>> is used rather than the word <<procedure>> on the buttons of the user interface.

After clicking the phase capture 21 button, the user will be presented with the dialog box illustrated in FIG. 5b. This dialog box includes a field 24 where the user can enter the file name of the file containing the scene description, and a button 25 that allows the user to browse through a file structure in order to locate this file. After the correct file name has been entered, the user will click a <<Next>>0 button 26, and a new dialog box will be opened.

FIG. 5c illustrates the next dialog box, which is similar to the one illustrated in FIG. 5b, except the file name that should be entered using field 27 or button 28, is the file name of an interaction file. This file contains information regarding relations between different objects in the scene, and may for instance define how and when various objects interact or interfere with each other. The user may return to the previous dialog box by clicking a <<Back>> button 29 or proceed to the next dialog box by clicking the <<Next>> button 30.

The next dialog box, illustrated in FIG. 5d, allows the user to select a file name where the input parameter log will be stored, using either the input field 31 to define a new file name or the browse button 32 to find an existing file. The <<back>> button 33 will return the user to the dialog box shown in figure 5c, while the <<Finish>> button 34 will start the process of recording the target execution of the procedure.

If the user clicks on the <<Phase Designer>> button 22 in the initial dialog box, a phase designer dialog box will be opened, as illustrated in FIG. 5e. This dialog box is used during creation of the procedure description. It should be noted that while the procedure description is created, the simulator will be running in a separate window, illustrated in FIG. 5f. The relevant input parameter log is loaded into the animator 9 and the animation is stopped automatically or manually each time the user wants to add information, as has been described above. Using the Phase Designer dialog box, the user can click the relevant tab in order to view and edit information regarding objects 37, interactions (interference) 38, topological stamps 39, guidance information 40 and physiological stamps. When the <<Objects>> tab 37 is activated, a window 42 shows the scene graph with all the objects present in the scene. A time indicator 43 indicates the progress of time in the procedure or the phase, and a field 44 lists topological history. Two buttons activate functions for interpolation 45 and enhancement 46 of the pivotation trajectories, as described above.

FIG. 5f shows the main simulator window. In this example the training scene includes two surgery tools 47, 48, a suture 49, a heart 50 and a vessel 51. The simulator window also includes a number of buttons 52 for starting and stopping the simulation, and for accessing information, changing visualization mode, and accessing other tools that control the simulation.

Finally, FIG. 5g shows a trainer dialog box that is opened when the trainer administrator 12 is activated by the <<Trainer>> button 23. This dialog box will be open during a training session, and allows the trainee, by way of radio buttons 53, 54 to change between animation and interaction as described above.

The invention has been described as a set of modules with a given functionality. As already mentioned, it must be understood that the actual software and/or hardware modules of a system according to the invention may be organized somewhat differently without falling outside the scope and spirit of the invention. As an example, the procedure designer could be realized as two different modules, one for recording the input parameter log of the target execution of the procedure, and one for creating the procedure description based on this input procedure log. Also, functionality belonging to one of these may be placed in separate modules or routines that may be called in order to perform e.g. interpolation of the pivotation trajectories. In a similar manner, data flow between the modules will obviously change if functionality is moved from one module to another.

It should also be noted that the data flow illustrated in FIG. 1 and FIG. 3 is simplified in the sense that it is not always illustrated how data may be stored and sometimes processed or aggregated before it arrives at the receiving module. As an example, FIG. 1 shows the input parameter log as being transferred directly from the instrument input device 2 to the procedure designer 6. It must be understood that this is a simplification, since the input parameter log is a log containing the sampled input parameters for an entire procedure (or phase). This sampling is preferably handled by the interaction interface 10—but it could also be handled by e.g. the procedure designer 6—and stored as a file in the database 7. Only after the recording of the target execution is completed is the entire input parameter log transferred from the database 7 to the procedure designer 6 (and loaded into the animator 9) for creation of the procedure description. The invention is preferably implemented as a number of software modules installed on a computer with the necessary hardware resources for running the simulation in question. This will normally include one or more central processors, capable of performing the instructions of the software modules, storage means on which the software modules will be installed, an input interface and an output interface. References to capabilities of the software modules, as any person skilled in the art will understand, means capabilities imparted on a computer system with the necessary resources when programmed with the relevant software module. The input interface will be connected to various input devices such as a mouse and a keyboard in addition to an instrument input device that represents the controls used when performing the relevant procedure live as opposed to as a simulation. The output interface will be connected to output devices such as a display, monitor, stereo display or visual reality (VR) goggles and loudspeakers.

The software modules will constitute computer program products that can be stored and distributed on storage devices such as disks, CD-ROM, DVD-ROM, or as propagated signals over a computer network such as the Internet.

1. System for designing procedure descriptions for use in a system for training persons to perform procedures involving manual dexterity and/or eye-hand coordination, said system comprising:
a computer system with one or more processors capable of processing computer program instructions, storage means for storing computer program instructions and data files, and input/output means for receiving input data and outputting data resulting from operations performed by said processing means under control of said program instructions,
said program instructions including instructions for making the computer system perform the functions of
controlling a geometrical scene description to be stored in said storage means and representing a training environment, receiving input control signals representing manipulation of objects in said training environment, and of delivering output signals representing a graphical description of said environment,
sampling input control signals from an instrument input device connected to the computer input/output means and storing the samples in an input parameter log file,
combining data from said input parameter log file or data derived from the input parameter log file with topological stamps that represent topological events taking place in the training environment, scene, and
storing the resulting combination in a procedure description file.

2. System according to claim 1, wherein said input control signals in addition to instrument position data include information on instrument clamping modes, and said program instructions further include program instructions for generating clamping mode tables and storing this clamping mode table in said procedure description file.

3. System according to claim 1 or 2, wherein said program instructions further include instructions for adding interference information, guidance information and physiological or environmental stamps to the procedure description file.

4. System for training persons to perform a procedure involving manual dexterity and/or eye-hand coordination, said system comprising:
a computer system with one or more processors capable of processing computer program instructions, storage means for storing computer program instructions and data files, and input/output means for receiving input data and outputting data resulting from operations performed by said processing means under control of said program instructions,
said storage means including a pre-designed geometrical scene description representing a training environment, and a pre-defined procedure description file with information sampled from an instrument input device during execution of the relevant procedure or data derived from such sampled input information and a series of topological stamps,
said program instructions including instructions for making the computer system perform the functions of
controlling a geometrical scene description stored in said storage means and representing a training environment, receiving input control signals representing manipulation of objects in said training environment, and of delivering output signals representing a graphical description of said environment,
delivering data from said pre-defined procedure description file as simulator input control signals in order to create an animated simulation when the system is in an animation mode,
delivering data received from an instrument input device connected to the computer input/output means to the simulator when the system is in an interactive mode, and
tracking the progress of any interaction relative to the topological stamps in the procedure file in order to administrate transitions from interactive mode animation mode and vice versa.

5. System according to claim 4, wherein pivotation trajectories derived from samples from said instrument input device are stored in said pre-defined procedure description file and said program instructions further include instructions for evaluating said pivotation trajectories and delivering the results of these evaluations sequentially as said simulator input control signals.

6. System according to one of the claims 4 and 5, wherein said program instructions further include instructions for tracking the progress of an interactive execution of a procedure during an interactive mode relative to a time scale or progress scale of the pre-defined procedure description file.

7. System according to claim 6, wherein said program instructions further include instructions for accessing additional information in said procedure description file and displaying or implementing said additional information in accordance with said progress of an interactive execution relative to the time or progress scale of the pre-defined procedure description file.

8. System according to claim 6 or 7, wherein said program instructions further include instructions for upon initiation of a transition from interactive mode to animation mode, locating a point along the time scale or progress scale of the procedure description file from which to resume the animation based on said tracking, and resuming animation from said point.

9. System according to claim 8, wherein said program instructions further include instructions for finding said point on said time scale or progress scale by returning to some previous point on said time scale or progress scale defined by a topological stamp present in the procedure description file.

10. System according to claim 8, wherein said program instructions further include instructions for finding said point on said time scale or progress scale by first locating two points on said scale defined by topological stamps in the procedure description file, one of which representing a topological event that has occurred during the interactive mode and the other of which representing a topological event that has not yet occurred, and then determining a point on said time or progress scale at which the positions of said instruments according to the pivotation trajectories in the procedure description file relative to the positions of the instruments as a result of their movement during the interactive mode, are optimal according to some defined rules.

11. System according to one of the claims 4 to 10, wherein said program instructions further include program instructions for sampling said control signals from said instrument input device while the system is in an interactive mode and storing the samples in an input parameter log file.

12. System according to claim 11, wherein said program instructions further include program instructions for performing a comparison of said pre-defined procedure description and said input parameter log and determine a quality of the input parameter log based on pre-defined quality criteria.

13. Method for creating a procedure description for use in a computer system for training persons to perform a procedure involving manual dexterity and/or eye- hand coordination, said method comprising:
loading a pre-defined geometrical scene description into a computer based simulator system,
sampling input information from an instrument input device while the relevant procedure is being performed on the simulator system,
storing said samples as an input parameter log,
combining the input parameter log or data derived from the input parameter log with topological stamps that represent topological events taking place during the execution of the procedure, and
storing the resulting combination in a procedure description file.

14. Method according to claim 13, further comprising defining a clamping mode table from information in the input parameter log defining various states of the instruments at various times during the progress of the recorded procedure and storing said clamping mode table in said procedure description file.

15. Method according to claim 13, wherein interference information, guidance information or physiological or environmental stamps are added to the procedure description file.

16. Method according to claim 13, wherein sampled positional data in said input parameter log are interpolated and continuous pivotation trajectories are generated and stored in the procedure description file as positional information derived from said input parameter log.

17. Method for training persons to perform a procedure involving manual dexterity and/or eye-hand coordination on a computer based simulation system, said method comprising:
loading a pre-defined geometrical scene description and a pre-defined procedure description file with information sampled from an instrument input device during execution of the relevant procedure or data derived from such sampled input information and a series of topological stamps, into a computer based simulator system,
delivering data from said pre-defined procedure description file as simulator input control signals in order to create an animated simulation when the system is in an animation mode,
delivering data received from an instrument input device connected to the computer input/output means to the simulator when the system is in an interactive mode, and
tracking the progress of any interaction relative to the topological stamps in the procedure description file in order to administrate transitions from interactive mode to animation mode and vice versa.

18. Method according to claim 17, further comprising evaluating pivotation trajectories derived from samples from said instrument input device and stored in said pre-defined procedure description file and delivering the results of these evaluations sequentially as said simulator input control signals.

19. Method according to one of the claims 17 and 18, further comprising tracking the progress of an interactive execution of a procedure during an interactive mode relative to a time scale or progress scale of the pre-defined procedure description file.

20. Method according to claim 19, further comprising accessing additional information in said procedure description file and displaying or implementing said additional information in accordance with said progress of an interactive execution relative to the time or progress scale of the pre-defined procedure description file.

21. Method according to claim 19 or 20, further comprising, upon initiation of a transition from interactive mode to animation mode, locating a point along the time scale or progress scale of the procedure description file from which to resume the animation, based on said tracking, and resuming animation from said point.

22. Method according to claim 21, further comprising finding said point on said time scale or progress scale by returning to some previous point on said time scale or progress scale defined by a topological stamp present in the procedure description file.

23. Method according to claim 21, further comprising finding said point on said time scale or progress scale by first locating two points on said scale defined by topological stamps in the procedure description file, one of which representing a topological event that has occurred during the interactive mode and the other of which representing a topological event that has not yet occurred, and then determining a point on said time or progress scale at which the positions of said instruments according to the pivotation trajectories in the procedure description file relative to the positions of the instruments as a result of their movement during the interactive mode, are optimal according to some defined rules.

24. Method according to one of the claims 17 to 23, further comprising sampling said control signals from said instrument input device while the system is in an interactive mode and storing the samples in an input parameter log file.

25. Method according to claim 24, further comprising performing a comparison of said pre-defined procedure description and said input parameter log and determine a quality of the input parameter log based on pre-defined quality criteria.

26. Computer program product comprising instructions for, when installed on a computer system, making the system capable of performing the method of any of the claims 13 to 25.

27. Computer program product according to claim 26, stored on a computer readable medium.

28. Computer program product according to claim 27, wherein said computer readable medium is a magnetic storage device.

29. Computer program product according to claim 27, wherein said computer readable medium is an optical or magneto-optical storage device.

30. Computer program product according to claim 27, wherein said computer readable medium is a CD-ROM or a DVD-ROM.

31. Computer program product according to claim 27, wherein said computer readable medium is a storage medium on a server located in a computer network.

32. Computer program product according to claim 26, embedded in a propagated communications signal.
